(19) United States
(12) Patent Application Publication
(10) Pub. No.: US 2025/0014407 A1
(43) Pub. Date: Jan. 9, 2025

(54) CONTROL UNIT FOR AN ACCESS POINT

(71) Applicant: Accessia Technology Ltd, Uxbridge (GB)

(72) Inventors: Paul Richard WITTY, London (GB); Nikola Ilkov BOZHINOV, London (GB); Mark Anthony Pius MENEZES, Welwyn Garden City (GB)

(73) Assignee: Accessia Technology Ltd, Uxbridge (GB)

(21) Appl. No.: 18/764,914

(22) Filed: Jul. 5, 2024

(30) Foreign Application Priority Data
Jul. 6, 2023 (GB) 2310446.6
Jun. 28, 2024 (GB) 2409423.7

(51) Int. Cl. G07C 9/25; G07C 9/00; H04N 7/18

(52) U.S. Cl. CPC G07C 9/257; G07C 9/00309; H04N 7/188; G07C 2209/63

(57) ABSTRACT

A control unit for an access point via which access to a restricted area can be granted to a subject, the control unit comprising one or more processors configured to: determine a positional state of a subject in dependence on data captured by one or more imaging devices; determine a positional state of an access device; assess whether the subject is in possession of the access device; and determine whether the positional state of the subject and/or the access device matches a predetermined characteristic associated with an intention to enter the access point; and if (i) the subject is in possession of the access device, (ii) the positional state of the subject and/or the access device matches a predetermined characteristic associated with an intention to enter the access point and (iii) the subject is authorized to access the restricted area, output a signal to indicate to the access point that access to the subject is to be granted.

### FIELD OF THE INVENTION

This invention relates to physical security systems, in particular to access point control systems, for example for a security door.

### BACKGROUND

Security systems are often installed in buildings, such as offices, hospitals and universities. Many physical security systems with access points such as doors having an electrically operated security locks use a key device such as a card, badge or fob to allow authorized subjects entry to restricted, access-controlled areas. From the information stored at the key, the system determines whether the subject is authorized to enter the area. If they are, the access point can be unlocked.

Traditional systems require a user to present the key to the reader at an access point to gain entry. Typically, the user must place the key such that it either makes direct physical contact with a reader or is within a few centimetres of it. This can be inconvenient for the user.

Some more recent systems can automatically allow access for some period of time when a key programmed to unlock the door is detected as being within a certain proximity. This can be more convenient for the user, as it allows contact-free access and does not require the user to locate their key and hold it to a reader. This can be particularly convenient if, for example, the user does not have their hands free.

However, this may result in a door being unlocked when the authorized person is not intending to enter the door. For example, an authorized user may be walking down a corridor past a door, but not intending to enter the door. This may pose a threat to the security of the access-controlled area, as an unauthorized person may be able to gain access while the door is unlocked.

It is desirable to develop a control unit for an access point that can overcome the above issues.

### SUMMARY OF THE INVENTION

According to a first aspect, there is provided a control unit for an access point via which access to a restricted area can be granted to a subject, the control unit comprising one or more processors configured to: determine a positional state of a subject in dependence on data captured by one or more imaging devices; determine a positional state of an access device; assess whether the subject is in possession of the access device; and determine whether the positional state of the subject and/or the access device matches a predetermined characteristic associated with an intention to enter the access point; and if (i) the subject is in possession of the access device, (ii) the positional state of the subject and/or the access device matches a predetermined characteristic associated with an intention to enter the access point and (iii) the subject is authorized to access the restricted area, output a signal to indicate to the access point that access to the subject is to be granted.

The one or more processors may be configured to determine that the subject is authorized to access the restricted area if one or more of the following is true: (i) the subject is determined, from the assessment, to be in possession of the access device (for example, the positional state of the access device corresponds to the positional state of the subject) and the access device is an authorized access device and (ii) if the identity of the subject determined from data captured by an imaging device matches a stored list of authorized subjects. The one or more processors may not output the signal if it is determined that the subject is not authorized to access the restricted area. The one or more processors may be configured to determine that the subject is not authorized to access the restricted area (and therefore not output the signal) if the subject is not in possession of the access device (for example, the positional state of the access device does not correspond to the positional state of the subject) and the access device is an authorized access device. The one or more processors may be configured to determine that the subject is not authorized to access the restricted area (and therefore not output the signal) if the identity of the subject determined from data captured by an imaging device does not match a stored list of authorized subjects.

The one or more processors may be configured to determine that the subject is authorized to access the restricted area if identity data stored at the access device corresponds to the identity of the subject determined from data captured by one or more of the imaging devices.

The one or more processors may be configured to raise an alert if the identity data stored at the access device does not correspond to the identity of the subject determined from data captured by the imaging device.

The subject may be a first subject. The one or more processors may be configured to, if a second subject is detected as being within a predetermined distance of the first subject (for example, from one or more images captured by the imaging device), perform a security action. The second subject may not be authorized to enter the restricted area. The one or more processors may be configured to determine that the second subject is not authorized to enter the restricted area. The second subject may not be in possession of an authorized access device (that is authorized for access to the restricted area). The one or more processors may be configured to assess whether the second subject is in possession of an authorized access device. The one or more processors may be configured to perform the security action if it is determined that the second subject is not authorized to enter the restricted area and/or is not in possession of an authorized access device.

The security action may comprise one or more of the following: raising an alert, reducing the amount of time that the first subject can gain access to the restricted area, permitting access to the first subject only when the first subject is within a predetermined distance of the access point, preventing further access once the first subject has entered the access point and triggering a further layer of verification in order to allow access to the first subject.

The one or more processors may be configured to determine whether the subject is in possession of the access device when (i.e. at a time, or a period of time, when) the access device and the subject are determined by the one or more processors to be more than the predetermined distance from the access point. If the subject is determined to be in possession of the access device when the access device and the subject are more than the predetermined distance from the access point, the one or more processors may be configured to subsequently determine whether the positional state of the subject matches a predetermined characteristic associated with an intention to enter the access point in dependence on data captured by an imaging device (and in some cases in dependence only on data captured by the imaging device). The imaging device may be the imaging device referred to above or a different imaging device.

The imaging device may be configured to capture images independently of the distance of the subject and/or the access device from the access point. The imaging device may be activated independently of the distance of the subject and/or the access device from the access point. The imaging device may be configured to operate (i.e. acquire images) continuously. The imaging device may be a closed-circuit television camera installed in a building.

The control unit may be configured to not permit access to the subject if it is determined that the subject is not in possession of the access device and/or the subject is not authorized to enter the restricted area and/or that the positional state of the subject and/or the access device does not match a predetermined characteristic associated with an intention to enter the access point.

The one or more processors may be configured to determine the positional state of the subject in dependence on information indicative of the subject's positional state, wherein the information comprises an indication of one or more of a location of the subject, a speed of the subject, a velocity of the subject, an orientation of the subject, a pose of the subject and a trajectory of the subject, or a change thereof with respect to time.

The one or more processors may be configured to determine the positional state of the access device in dependence on one or more radio frequency signals transmitted by the access device (such as Bluetooth Low Energy or Ultra-Wide Band signals). The predetermined characteristic associated with an intention to enter the access point may comprise one or more of the following: the location of the subject and/or the access device is within a predetermined distance of the access point, the speed or velocity of the subject and/or the access device is less than a predetermined threshold and the orientation of the subject and/or the access device is within a predetermined angular range with respect to the access point.

According to another aspect, there is provided a method for implementation at a control unit for an access point via which access to a restricted area can be granted, the method comprising: determining a positional state of a subject in dependence on data captured by one or more imaging devices; determining a positional state of an access device; assessing whether the subject is in possession of the access device; and determining whether the positional state of the subject and/or the access device matches a predetermined characteristic associated with an intention to enter the access point; and if (i) the subject is in possession of the access device, (ii) the positional state of the subject and/or the access device matches a predetermined characteristic associated with an intention to enter the access point and (iii) the subject is authorized to access the restricted area, outputting a signal to indicate to the access point that access to the subject is to be granted.

One or more of the following may also be true for any of the above aspects.

The imaging device(s) may be located outside of the access point (i.e. outside of the restricted area).

The control unit may be configured to not permit access to the subject (i.e. not send the signal) if it is determined that the subject is not authorized to enter the restricted area and/or that the subject's and/or access device's positional state does not match a predetermined characteristic associated with an intention to enter the access point and/or that the subject is not in possession of the access device.

The one or more processors may be configured to receive information indicative of the positional state of the access device and/or the subject. The information indicative of the positional state may comprise an indication of one or more of a location of the subject or the access device, a speed of the subject or the access device, a velocity of the subject or the access device, an orientation of the subject or the access device, a pose of the subject and a trajectory of the subject or the access device, or a change in the location, the speed, the velocity, the orientation, the pose or the trajectory over time.

The subject's and/or the access device's positional state may be determined by the one or more processors. The subject's and/or the access device's determined positional state may be relative to a respective spatial reference point at the access point. The reference point may be a predefined reference point. The reference point may be defined by a user of the system, or may be a preconfigured reference point which may correspond to example, the geometric midpoint of the access point (for example, a door), or the position of a handle or push plate. One or more predetermined characteristics associated with an intention to enter the access point may be defined relative to the reference point.

The one or more processors may be configured to determine whether the subject is authorized to enter the restricted area in dependence on identity information corresponding to the subject. The identity information may be determined by analysing biometric information or one or more images of the subject. The one or more images may be captured by the imaging device.

The information indicative of the subject's and/or the access device's positional state may be determined in dependence on one or more radio frequency signals transmitted by an access device carried by the subject. The one or more radio frequency signals may comprise one or more Ultra-Wide Band signals. The identity information may be stored at the device and received from the device by the control unit. The identity information may be received from the device in the form of a digital certificate over an encrypted communication channel. The device may be a fob, a badge or a user device. For example, the device may be a mobile phone. The access device may store an access token. The control unit may receive the access token from the device.

The information indicative of the subject's and/or access device's positional state may be received from a locating system (or one or more components thereof) communicatively connectable to the control unit.

The locating system may comprise an imaging device. The information indicative of the subject's positional state may comprise one or more images captured by the imaging device or data derived from one or more images captured by the imaging device. The locating system may comprise one or more positioning units. Each positioning unit may be communicatively connectable to the access device. The locating system may be configured to trilaterate signal information for radio frequency signals transmitted between the device and three or more positioning units.

The one or more processors may alternatively or additionally be configured to process the information to determine whether the subject's and/or the access device's positional state matches a predetermined characteristic associated with an approach to the access point. If it is determined that (i) the subject's and/or the access device's positional state matches a predetermined characteristic associated with an approach to the access point and (ii) the subject is authorized to access the restricted area, and that the subject is in possession of the access device, the one or more processors may be configured to output the signal to indicate to the access point that access to the subject is to be granted. The control unit may be configured to not permit access to the subject if it is determined that the subject is not authorized to enter the restricted area and/or that the subject's and/or access device's positional state does not match a predetermined characteristic associated with an approach to the access point. One or more predetermined characteristics associated with an approach to the access point may be defined relative to the reference point.

The predetermined characteristic associated with an intention to enter (or with an approach to) the access point may comprise or specify, for example, an orientation and/or a velocity of the subject and/or the access device. The predetermined characteristic associated with an intention to enter (or with an approach to) the access point may comprise one or more of the following non-limiting examples: the subject's and/or access device's location is within a predetermined distance of the access point (for example, within a predetermined distance of a reference point at the access point, which may be a position defined on a map), the subject's and/or the access device's speed or velocity is less than a predetermined threshold and the subject's and/or the access device's orientation is within a predetermined angular range with respect to the access point (for example, within a predetermined angular range of a reference point or orientation defined at the access point).

The access point may comprise an electrically controlled lock. The control unit may be configured to send the signal to the electrically controlled lock. The signal may cause the lock to transition from a locked state to an unlocked state.

The access point may be a physical access point of a building. The access point may be a door.

The one or more processors may be configured to: receive one or more first signals comprising information indicative of the subject's and/or the access device's positional state; determine a first positional state of the subject and/or the access device based on the one or more first signals and/or a first technique; if it is determined that the subject's and/or the access device's first positional state matches a first predetermined characteristic associated with an intention to enter (or with an approach to) the access point: receive one or more second signals comprising information indicative of the subject's and/or the access device's positional state; determine a second positional state of the subject and/or the access device based on the one or more second signals and/or a second technique; if it is determined that the subject's and/or the access device's second positional state matches a second predetermined characteristic associated with an intention to enter (or with an approach to) the access point, and that the subject is authorized to access the restricted area, output the signal. The one or more processors may be configured to receive the one or more second signals at a higher frequency than the one or more first signals. The one or more first signals may be Bluetooth Low Energy signals. The one or more second signals may be Ultra Wide Band signals.

The one or more processors may be configured to initiate (and/or partake in) one or more data exchange sessions (for example, between one or more positioning devices of the locating system and the device configured to be carried by the subject) to determine information indicative of the subject's and/or the access device's positional state at a respective time. The one or more processors may be configured to determine a time period between the initiation of a first data exchange session and a second data exchange session based on information indicative of the subject's and/or the access device's positional state obtained during the first data exchange session. The one or more processors may then initiate (and/or partake in) the second data exchange session once the determined time period has elapsed. The data exchange sessions may be ranging sessions. The data exchange sessions may be between one or more positioning units of the locating system and the device carried by the subject. The data exchange sessions may be used to obtain information indicative of the distance between two or more devices (for example, between a respective positioning device and the device carried by the subject). The data exchange sessions may obtain data used to determine the information indicative of the subject's positional state at a respective time. The subject's positional state may be determined relative to a reference point at the access point. The first data exchange session may obtain data used to determine information indicative of the subject's positional state at a first time. The second data exchange session may obtain data used to determine information indicative of the subject's positional state at a second time later than the first time. The time period between the initiation of data exchange sessions may be reduced if it is determined from information indicative of the subject's and/or the access device's positional state obtained during one or more previous data exchange sessions provides a preliminary indication that the subject and/or the access device is approaching or intending to enter the access point. If the subject's and/or the access device's positional state determined from information indicative of the subject's and/or the access device's positional state obtained during a subsequent data exchange session matches a predetermined characteristic associated with an intention to enter (or approach) the access point and the subject is authorized to access the restricted area, the control unit may then output the signal to indicate to the access point that access to the subject is to be granted. The initiation of a data exchange session may in some examples comprise sending a signal to another device to instruct it to perform a data exchange session at a particular time. The other device may then acquire information indicative of the subject's positional state, which is received by the one or more processors of the control unit and processed.

According to a further aspect, there is provided a computer program comprising instructions that when executed by a computer cause the computer to perform the method above.

According to a further aspect, there is provided a computer-readable storage medium having stored thereon computer readable instructions that when executed at a computer (for example, comprising one or more processors) cause the computer to perform the method above. The computer-readable storage medium may be a non-transitory computer-readable storage medium. The computer may be implemented as a system of interconnected devices.

### BRIEF DESCRIPTION OF THE FIGURES

The present invention will now be described by way of example with reference to the accompanying drawings. In the drawings:

FIG. 1 schematically illustrates a building comprising multiple restricted areas, each restricted area having a controlled access point.

FIG. 2 schematically illustrates an example of some components of an access control system.

FIG. 3 schematically illustrates further detail of the exemplary access control system of FIG. 2.

FIG. 4 schematically illustrates the determination of the location of a device using two way ranging.

FIG. 5 schematically illustrates the determination of the location of a device using time difference of arrival.

FIG. 6 schematically illustrates a first exemplary scenario.

FIG. 7 schematically illustrates a second exemplary scenario.

FIG. 8 schematically illustrates a third exemplary scenario.

FIG. 9 schematically illustrates a fourth exemplary scenario.

FIG. 10 shows a flowchart showing the steps of an exemplary method for implementation by a control unit for an access point.

FIG. 11(a) shows an example of a computing device that may be used to implement the control unit, access control reader and/or positioning unit described herein and some of its associated components.

FIG. 11(b) shows an example of a device and some of its associated components.

FIG. 12 schematically illustrates a fifth exemplary scenario.

FIG. 13 schematically illustrates a sixth exemplary scenario.

FIG. 14 shows a flowchart showing the steps of a further exemplary method for implementation by a control unit for an access point.

### DETAILED DESCRIPTION

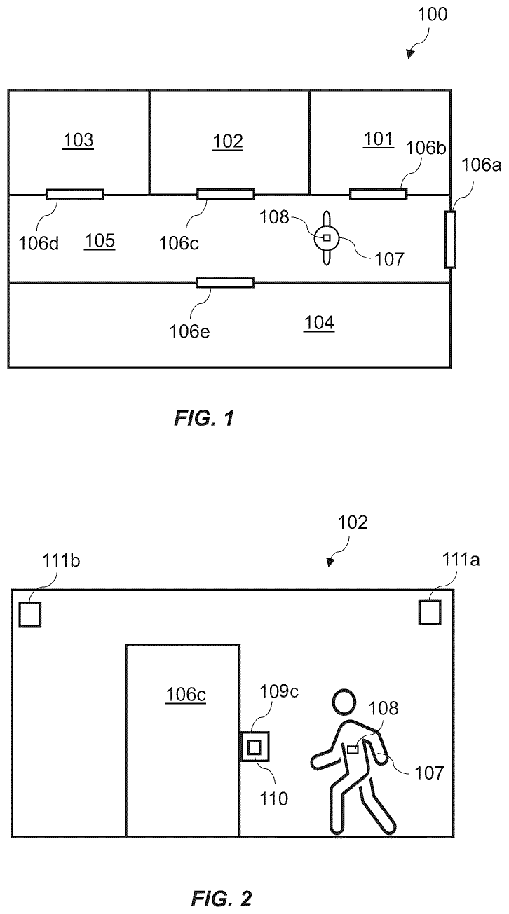

FIG. 1 shows an example of a building 100. The building comprises a physical security system. The building 100 comprises one or more restricted areas to which access is controlled. In this example, the building 100 comprises multiple rooms 101, 102, 103, 104 and a corridor 105. The rooms and corridor are each restricted areas, which may also be referred to as access-controlled areas. Access to each room, and access to the corridor from outside of the building, is provided by a physical access point, such as a door 106. In this example, each access point 106a, 106b, 106c, 106d, 106e has an electrically controlled lock. For example, the lock may be a magnetic lock having an electromagnet that can be selectively energized to put the access point into a locked state. To unlock the access point, the lock receives a signal to demagnetize the electromagnet, which transitions the access point from its locked state to an unlocked state.

A subject is shown inside the building at 107. In this example, the subject 107 is a human user. In other implementations, the subject may be non-human. For example, the subject may be an animal or a robot. In this example, the subject carries an access device 108 storing and/or displaying information that can be used to identify the subject 107. The device 108 may be portable. The device 108 can act as a digital key or access token to the access point if the subject 107 is authorized to access the controlled area corresponding to the access point. Such devices may comprise a badge, fob, smartphone, tablet or other mobile computing device. The device may be a user device. The device 108 may comprise a power source, such as a battery.

In this example, each door 106a-e comprises a control unit and an access control reader. The access control reader may be communicatively connectable to the control unit. The control unit may be separate to the reader or may be integral with it.

FIG. 2 shows an example of an access point in more detail. Door 106c is an access point to room 102 of FIG. 1. In FIG. 2, the subject 107 is walking down corridor 105 and is carrying the device 108, for example in a pocket of their clothing. In this example, an access control reader 109c is located at the access point 106c. The access control reader comprises a control unit 110.

Each of the doors 106a-e in FIG. 1 may have a respective access control reader. In some implementations, the control unit 110 may be common to all of the access points in the building, or each access point may have its own control unit for controlling access to its respective restricted area.

Control unit 110 is communicatively connectable to the device 108. Control unit 110 is also communicatively connectable to one or more positioning units (which may also be referred to as anchors).

The device 108 may be configured to wirelessly broadcast identity information that can be used to authenticate the subject and provide access to a restricted area if the subject is an authorized user for the access point corresponding to the restricted area. The identity information may, for example, be sent wirelessly to the reader via a radio frequency signal, such as Radio Frequency Identification (RFID) or Ultra-Wide Band (UWB) radiation.

In other implementations, the identity information may be obtained from biometric information for the subject, for example using a fingerprint or retinal scanner. The identity information may be obtained from a machine-readable code on the subject or on the device, such as a barcode or QR code. Alternatively, facial recognition of the subject may be used. Such scanners or a camera for performing facial recognition from a captured image may be part of the access control reader, or may be otherwise communicatively connectable to the control unit. In such examples, a device 108 carrying information that can be used to identify the subject may not be used. In some implementations, identity information from one or more biometric or facial recognition identification methods may be used in addition to identity information for the subject that is stored at or displayed on the device 108 to provide an additional layer of security.

In some implementations, the system comprises a locating system that can estimate the absolute location and/or orientation of the subject and/or their relative location and/or orientation relative to one or more access points. The locating system may estimate the relative location and/or orientation of the subject relative to a respective spatial reference point at a respective access point. The reference point may be a predefined reference point. The absolute position of the reference point may be known and/or fixed. The reference point may in some examples not be associated with any device, but in other examples may be chosen to coincide with the spatial location of one or more devices, such as the access control reader for the access point. Using the techniques described herein, the positional state of the subjected may be determined relative to the reference point. Each access point may have a corresponding reference point. The reference point may be defined by a user of the system (for example, chosen on a map of the building), or may be a preconfigured reference point. For example, the reference point may be a position corresponding to the geometrical centre of an access point (e.g. the centre of the door) or a specific feature of the access point, such as a handle or push plate.

In the examples described below, the locating system infers the positional state (for example, the location and/or orientation of the subject) based on information relating to the positional state of the device that is carried by the subject. The information may be determined using any suitable known localization technique, such as time of flight or time difference of arrival of radio frequency radiation, as will be described in more detail below. In other implementations, the locating system may use different methods to determine the absolute or relative location and/or orientation of the subject. For example, the locating system may process closed circuit television (CCTV) images of a subject that are analysed to determine the location and/or orientation (or the pose) of the subject relative to a particular access point.

In the examples described below, the locating system comprises one or more positioning units. Two positioning units 111a and 111b are shown in FIG. 2. Each positioning unit is communicatively connectable to the device 108. The communication between the device 108, the access control reader 109c and control unit 110 (which in this example is part of the reader 109) may be wireless, as described in more detail below, or some of the components, such as the access control reader 109 and the positioning units 111a, 111b, may communicate via wired connections, for example via wires located within the walls of the room.

The respective position of each of the positioning units may be fixed and/or known. In some implementations, the reader 109 may also operate as a positioning unit. The relative location of each positioning unit is known to the control unit 110. The positioning units may have any location within or around the building or in the vicinity of it. Preferably, each positioning unit runs a clock having the same base as the other positioning units (i.e. the positioning units are time-synchronised).

The locating system may comprise a single positioning unit or multiple positioning units. For example, where the locating system comprises a single positioning unit, this may be part of the same unit as the access control reader. A single access control reader (acting as a positioning device such as a UWB anchor) may measure distance and direction in the horizontal plane. By using multiple positioning units, the device's location can be determined in 2D space (or in 3D space, if there are positioning units located at different heights, such as on multiple floors of the building).

When using multiple positioning units or anchors, the location of the units may be fixed and/or known. For example, an administrator of the system may correctly position the units on a map, such that location of each positioning unit is known by the locating system. Alternatively, a location determination technique (for example using Bluetooth or UWB signals) may be used by the locating system to calculate the relative positions of the positioning units. In order to more accurately estimate the location of a device, the distances from the device to each positioning unit may be taken at a similar time.

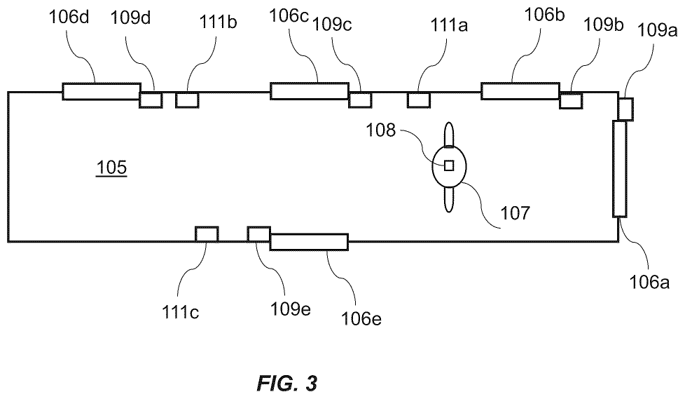

FIG. 3 shows an exemplary arrangement of devices in corridor 105 in more detail. Each access point 106a, 106b, 106c, 106d, 106e has a corresponding access control reader 109a, 109b, 109c, 109d, 109e. Each access point may comprise its own control unit, or there may be a common control unit for all of the access points. In FIG. 3, three positioning units 111a, 111b and 111c are shown. Using three or more positioning units may be particularly advantageous, as this may allow the position of the device 108 to be determined more accurately using trilateration.

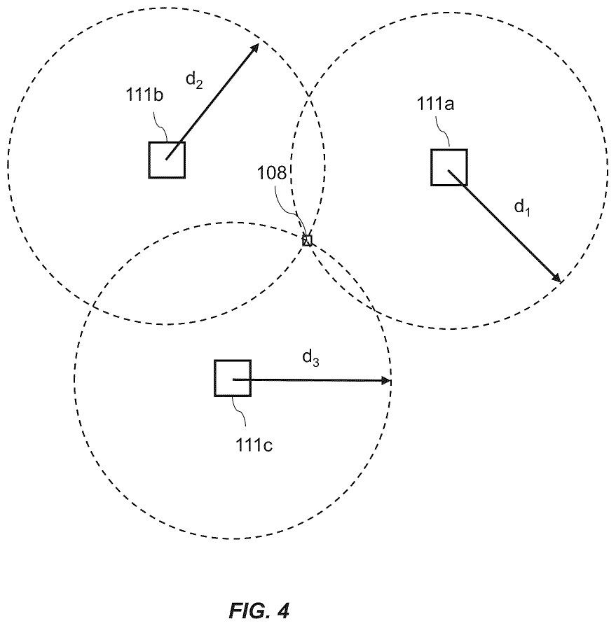

As schematically illustrated in FIGS. 4 and 5, the locating system may determine the position of the subject based on radio frequency (RF) signals sent or received by the device 108. The locating system may use a localization technique, such as time of flight (ToF) or time difference of arrival (TDoA) of transmitted radio frequency signals, to determine the position of the subject. The locating system may use trilateration of radio frequency signals sent between the device 108 and each positioning unit 111a, 111b, 111c to determine the position of device 108. The RF radiation may be transmitted using ultra wide band (UWB), Bluetooth, WiFi or according to some other protocol.

In one implementation, the user device 108 emits UWB radiation. UWB is an RF communication protocol that uses a wide portion of the frequency spectrum to minimise conflict with other UWB devices, and also to mitigate the effects of multipath reflections that may prevent accurate measurements of the time of flight. UWB uses around 500-MHz bandwidth per channel. This can be between 3.1 and 10.6 GHz. Typically, UWB operates between 6 and 8.5 GHz. The low frequency of UWB pulses enables the signal to effectively pass through common objects such as walls, furniture, and other objects, making it particularly suitable for use indoors.

UWB signals can be used to determine the position of the device 108. UWB positioning can use the TDoA of the UWB signals to determine the position of the device. UWB can provide accurate measurements of the device's location down to a few centimeters. In addition, it has strong security as a result of its physical layer (PHY).

The position of the subject at a given time may be determined based on measurements of RF signals transmitted by the device 108 and/or the positioning units 111. The measurements may be based on ToF and/or Angle of Arrival (AoA), or TDoA. In principle, if the transmitter (which could be the user device or a fixed device such as a positioning unit) and the receiver were time-synchronised to a high precision then a signal to/from one positioning unit would give an indication of the distance between the user device and the positioning unit. In practice, devices are often not sychronised to a high level of precision, so multiple fixed devices whose relative locations are known can be used, and signals are sent between them, one way or the other. The use of such a system does not require precise synchronisation between the fixed positioning units and the user device. Synchronisation between the fixed positioning units is easier to achieve because, for example, the units could be wired to a network with their clocks synchronised.

Therefore, the device 108 may transmit signals that are received by the positioning unit(s) 111, or alternatively the positioning units may transmit signals that are received by the device, and ToF, AoA or TDoA measurements may be used to determine the absolute or relative location of the device.

In FIG. 4, the location of the device 108 is determined from ToF measurements between the device 108 and each of the positioning units 111a, 111b, 111c. A two way ranging method can be used to determine the time of flight of the radio frequency signal (for example UWB) between the device and each of the positioning units, which can then be used to calculate the distance between the device and each of the positioning units by multiplying the time of flight by the speed of light.

In one implementation, the device 108 may initiate the two way ranging process by sending a poll message to a known address of a positioning unit at a time referred to as the time of sending poll (TSP). The positioning unit records the time of poll reception (TRP) and replies with a response message at a time of sending response (TSR). Upon reception of the response message, the device records the time of reception of response (TRR) and composes a final message to send to the positioning unit, where the ID of the device, TSP, TRR and time of sending final message (TSF) are included. Based on the time of reception of the final message (TRF) at the positioning unit and the information provided in the final message, the respective positioning unit can determine the time of flight of the radio frequency signal. This can be multiplied by the speed of light to determine the distance between the device and the respective positioning unit.

For a respective positioning unit, the distance between the device and the positioning unit can be determined as follows:

$$ToF = [ ( TRR - TSP ) - ( TSR - TRP ) + ( TRF - TSR ) - ( TSF - TRR ) ] / 4$$

$$distance = ToF \times ( speed of light )$$

This process can be performed for all positioning units. Optionally, the determined distance can be sent back to the device or to the control unit.

Alternatively, the positioning units may each send a poll message to the device at TSP which is received at the device at TRP, which sends a response message back to the respective positioning unit at TSR, before the final message is sent back to the device at TSF. The distance can be determined as above at the device, or the time data can be sent to a control unit for processing.

After the ranging process has been performed for all of the positioning units, each unit 111a, 111b, 111c has a corresponding distance d₁, d₂, d₃ from the device 108, as shown in FIG. 4. The intersection of three circles with radii d₁, d₂, d₃ can be used to determine the location of the device 108. From the determined location, the control unit can determine how far the device is from the access point (for example, how far the device 108 is from the reader 109).

In the example shown in FIG. 5, a radio-frequency signal (for example a UWB signal) is transmitted by the device 108. The signal is captured at positioning units 111a, 111b and 111c, which are within range of the device 108. Using this scheme, the positioning units are running the same clock.

The device 108 transmits a short Blink message at regular intervals (known as the refresh rate). Generally, the Blink message is processed by all of the positioning units in the communication range. The positioning units each send respective time stamps for the time when they received the Blink message to the control unit. To calculate the location of the device 108, the control unit may only consider timestamps coming from at least three positioning devices with the same clock base.

The signal captured at each positioning unit is shifted in time to find a position of maximum alignment. The time shift necessary to align each received signal is multiplied by the speed of light to obtain a distance difference between each receiver. The distance difference can be plotted as a set of hyperbolic lines. In FIG. 5, two hyperbolic lines are shown, one for the a first time difference (TD1) between the time of arrival of the Blink message at unit 111b and 111c (Tb−Tc) and a second for a second time difference (TD2) between the time of arrival of the Blink message at unit 111b and 111a (Tb−Ta). The intersection of the lines indicates the location of the device 108.

As the locations of the positioning units are know, this can be used to determine the absolute location of the device, or its location relative to other entities with known locations (such as the access control readers or other points of reference at the access point).

When using the TDoA method, the device 108 does not communicate with the positioning units individually and does not know their addressing range. This can lead to prolonging of battery life relative to two way ranging methods, since the device can send only one Blink message in order to be localized in space. In comparison, two way ranging methods use the exchange of 9 messages to localize the device using trilateration. Therefore, using TDoA, the battery life of the device may be prolonged.

The position of the device may be determined periodically and stored, for example at a memory accessible to the control unit.

Therefore, the positioning units can each receive RF signals from the device. The device may emit packets of RF radiation comprising identification (ID) and timestamp data. The ID data may comprise the user identification information and/or may comprise information identifying the device. The positioning units can detect and forward signal data, and/or the time and/or distance/location obtained therefrom, to the control unit for processing.

In other implementations, the positioning units may each act as transmitters and may each emit a radio frequency signal. The device may act as the receiver and receive the signals from each of the positioning units. The time of arrival measurements can be used in the same way as described above to determine the position of the device. The receiving device(s) can forward data relating to the received signals to the control unit, which can process the data to determine the location of the device.

In other implementations, the positional state of the subject may be determined based on, for example, closed circuit television (CCTV) images of a subject that are analysed to determine one or more of the location, orientation or pose of the subject. For example, images of the subject may be analysed to determine their location relative to the access point and/or whether the orientation of the subject is within a predetermined angular range of the access point.

The control unit 110 can process the identity information (for example, received from the device 108 or determined from biometrics or images of the subject) to determine whether the subject is authorized to enter the restricted area. The identity information may, for example, be processed by comparing it to a database of authorized subjects to determine whether the subject corresponding to the identity information is authorized to access the restricted area.

The control unit also processes the information indicative of the positional state of the subject, which may include data indicating a location, orientation, pose, speed, velocity or trajectory of the subject. This may be determined based on signals emitted by the device 108, as described above. The data indicative of the subject's positional state may be received from the device and/or from one or more positioning devices.

The control unit for the access point runs control logic that decides whether to allow access to the subject 107, for example by sending a signal to unlock the lock of the door. The decision to grant access to the subject is based on a determination that the subject's positional state matches a predetermined characteristic associated with an intention to enter the access point and on a determination that the subject is authorized to access the restricted area.

One or more predetermined characteristics associated with an approach to and/or with an intention to enter the access point may be stored in a database or lookup table. The predetermined characteristics may be ranges of a particular characteristic. The control unit can process the information to determine whether it matches (for example, falls within a range) any of the predetermined characteristics associated with an approach to and/or an intention to enter the access point by comparing it with the predetermined characteristics stored in the database or lookup table.

The information indicative of the subject's position state may be measured for a particular instant or over a period of time. For example, the information may indicate the subject's location at a particular instant. The information may indicate the instantaneous speed or velocity of the subject. The control unit may receive information indicative of the user's positional state periodically. In dependence on the information, the control unit may determine, for example, the instantaneous location, velocity or orientation of the subject. The velocity of the user can be determined as the rate of change of location and the location can also be determined as a function of time to give the subject's trajectory.

The processed data can be used to infer whether the subject is approaching the access point and/or intends to enter the access point. It may be assumed that the subject is moving forwards (i.e. a user is walking forwards as opposed to backwards).

One or more of the following non-limiting characteristics of a subject's positional state may be associated with an intention to enter the access point or with an approach to the access point:
the subject is within a predetermined distance of the reference point at the access point (for example, the subject is within a predetermined distance of the access control reader);
the subject is moving (for example, their location is changing) within a predetermined distance of the reference point. In some implementations, an intention to enter the access point may be associated with the subject (or specifically the location of the subject) having moved within a predetermined time period (for example, within the last 2 seconds). This may also be used where it is desirable to prolong the life of a power source of the device by sampling less frequently;
the subject is moving at a speed or velocity that is less than a predetermined threshold;
the subject has stopped (i.e. their rate of change of location has reduced to zero) within a predetermined distance of the reference point;
the subject is facing the access point, or has an orientation that is within a predetermined angular range of the access point (for example, relative to a reference point or reference orientation with respect to the access point);
the subject is moving towards the access point (for example, towards the reference point);
the predicted trajectory of the user (which may be based on their previous trajectory during a predetermined time period and/or their current orientation) is towards the access point (for example, towards the reference point);
the subject is decelerating within a predetermined distance of the reference point. This may be measured using an accelerometer of the device, or alternatively as the second derivative of the determined location with respect to time;
the subject is moving towards the reference point at the access point at a constant angle.

This may indicate that the subject is approaching the access point and intending to enter it, whereas for a subject passing by an access point by not intending to enter, the angle may change at a rate inversely proportional to distance;
the subject is on the outside of the access point, as opposed to the inside the restricted area. This may be determined by angle measurement with respect to the reference point at the access point;
where the subject is a human user, the user is detected to be walking. This may be determined using step detection from one or more accelerometers of the device. The device may then indicate this to the control unit.

The thresholds and weightings of these mechanisms can be modified depending on the subject. For example, a wheelchair user may require the access point, for example the door, to open when they are at a greater distance from it.

If the control unit determines that the positional state of the subject matches one or more characteristics associated with an intention to enter the access point, and that the user is authorized to access the restricted area that the access point allows entry to, a signal is sent to the access point. The signal indicates to the access point that access to the subject is to be granted. In response to receiving the signal, the access point may transition from a state in which the subject cannot access the restricted area to a state where the subject can access the restricted area. For example, where the access point is a door having an electrically operated lock, receipt of the signal by the access point may cause the lock to transition from a locked state to an unlocked state, thus allowing the subject access to the restricted area.

If the control unit determines that the positional state of the subject does not match one or more characteristics associated with an intention to enter the access point or with an approach to the access point, and/or that the user is not authorized to access the restricted area that the access point allows entry to, the control unit is configured to not permit access to the subject. The control unit may ignore (for example, not process) the identity information if the subject's positional state is determined to not match a predetermined characteristic associated with an approach to the access point or an intention to enter the access point.

As mentioned above, the positional state of the subject may be determined relative to a reference point at the respective access point. Therefore, the determined positional state may be a positional state relative to this reference point. In some embodiments, the one or more processors of the control unit may determine the positional state of the subject relative to the reference point from the received information indicative of the subject's positional state.

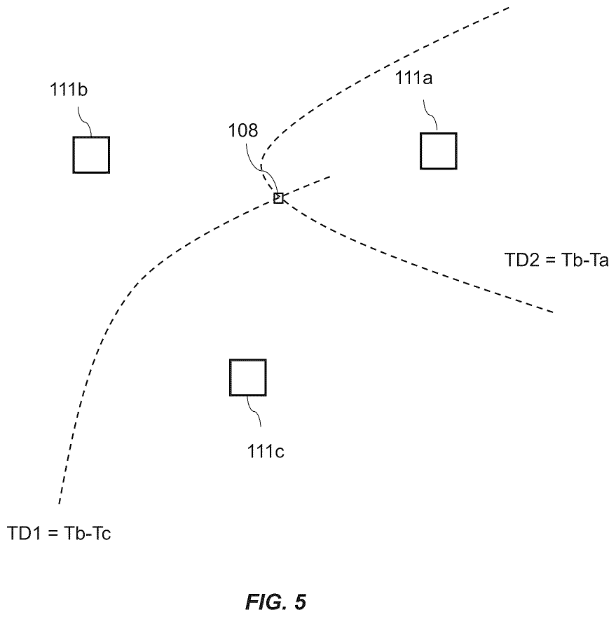

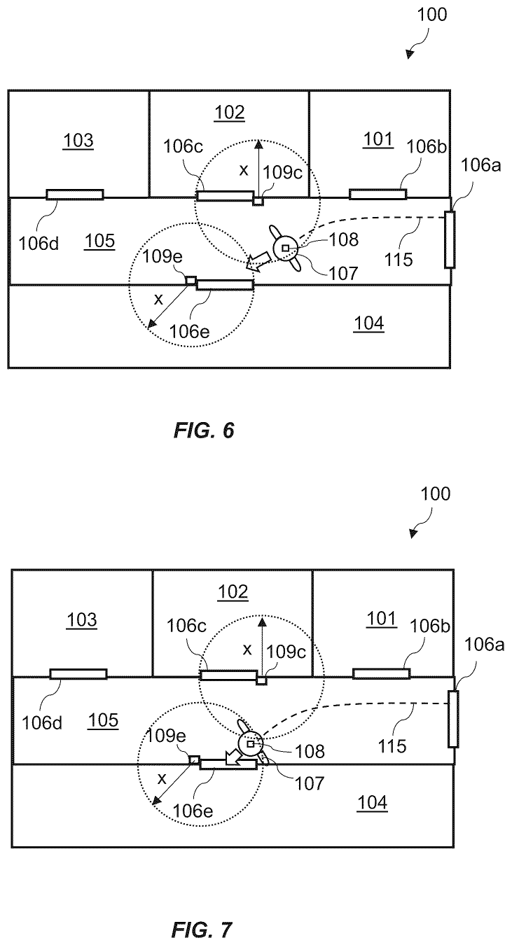

In the exemplary scenario shown in FIG. 6, predetermined characteristics associated with an intention to enter the access point specify a location range (specifically, whether the subject is within a predetermined distance x of the reference point at the access point) and an orientation range of the subject with respect to the access point. As shown in FIG. 6, the subject 107 is within a predetermined distance x of the access control reader 109c, which is the reference point in this particular example. In other examples, the reference point may be located elsewhere and may not correspond to any of the devices shown in the figures. In this example, the information indicative of the subject's positional state includes data indicative of the subject's location, and the control unit processes the data to determine that the subject is within a predetermined distance of the reference point. The control unit also receives identification information for subject 107 and determines that subject 107 has been authorized access to the restricted area 102. However, the information indicative of the positional state for the subject also indicates that the subject 107 is facing away from the access point 106c and is instead facing towards access point 106e. The orientation of the subject is not within a predetermined angular range of a reference orientation the access point. The reference orientation may be defined relative to the reference point. The angular range may be, for example, 90 degrees or 45 degrees. The reference orientation of the access point may be the normal to the plane of the access point (i.e. the plane of the door) at the location corresponding to the reference point. The trajectory of the user, determined as their location as a function of time, is also shown at 115. This data also indicates that the user is walking away from access point 106c. Therefore, access is not permitted to access point 106c.

At the point in time shown in FIG. 6, the subject 107 is not within a predetermined distance x of the access control reader 109e for access point 106e, which controls access to access-controlled area 104.

In FIG. 7, the subject 107 has progressed to being within a predetermined distance x of the reference point, which in this example corresponds to the spatial position of the access control reader 109e for access point 106e, which controls access to access-controlled area 104. In this example, the data indicative of the user's positional state indicates that the subject is moving towards the reference point at access point 106e. The user's positional state is determined to match a predetermined characteristic associated with an intention to enter the access point, because the subject is determined as being within a predetermined distance x of the reference point (the access control reader 109e) for access point 106e and is determined as having an orientation that is within a predetermined angular range of the reference point for the access point.

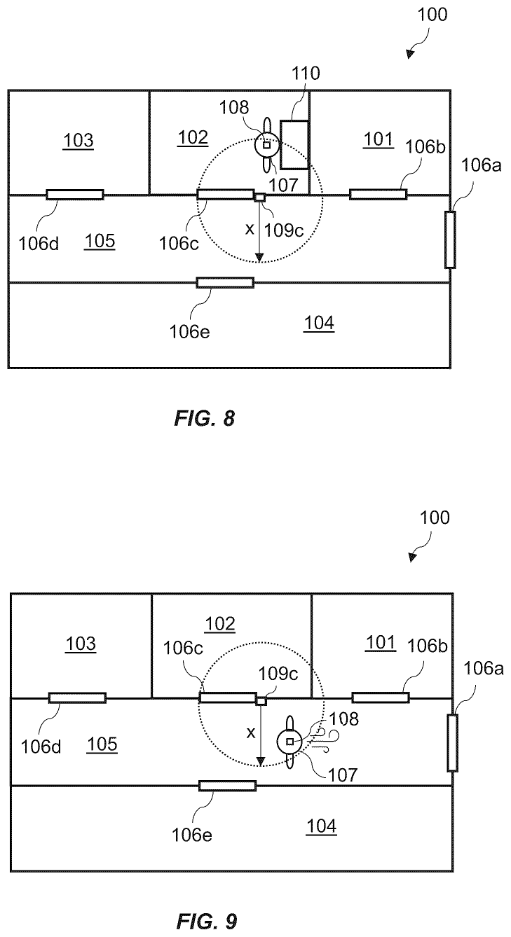

In the exemplary scenario shown in FIG. 8, the subject 107 is sat at a desk 110 in room 102. The user is authorized to enter the restricted area 102. The device 108 is within a predetermined distance x of the reference point (the access reader 109c) for the access point 106c. However, the subject 107 is detected as being stationary for more than a predetermined amount of time. In this case, the control unit does not send a signal to the access point 106c to grant access to the subject. This can prevent the door from being unlocked, which may allow an unauthorized user to access the room 102.

In the exemplary scenario shown in FIG. 9, from the information indicative of the subject's positional state, the subject 107 is determined as being within a predetermined distance x of the access reader 109c of access point 106c, which is the reference point for the access point in this example. From the information indicative of the subject's positional state, the subject is also determined to be moving at a speed that is above a predetermined threshold. If the subject is determined as moving at a speed that corresponds to, for example, running when they are within the predetermined distance x of the reader, it can be expected that they are not intending to stop at door 106c. In this case, the predetermined condition associated with an intention to enter the access point specifies that the subject is within a predetermined distance of the access point and that the subject is moving at less than a predetermined speed. Thus, if the data indicative of the user's positional state indicates that the subject is moving quickly (for example running) it can be expected that they will not stop at the door and the control unit does not permit access to the subject. The control unit may ignore identity information read by the reader unless the subject is determined to be moving towards the access point or is moving at less than a predetermined speed or stops within a predetermined distance of the access point.

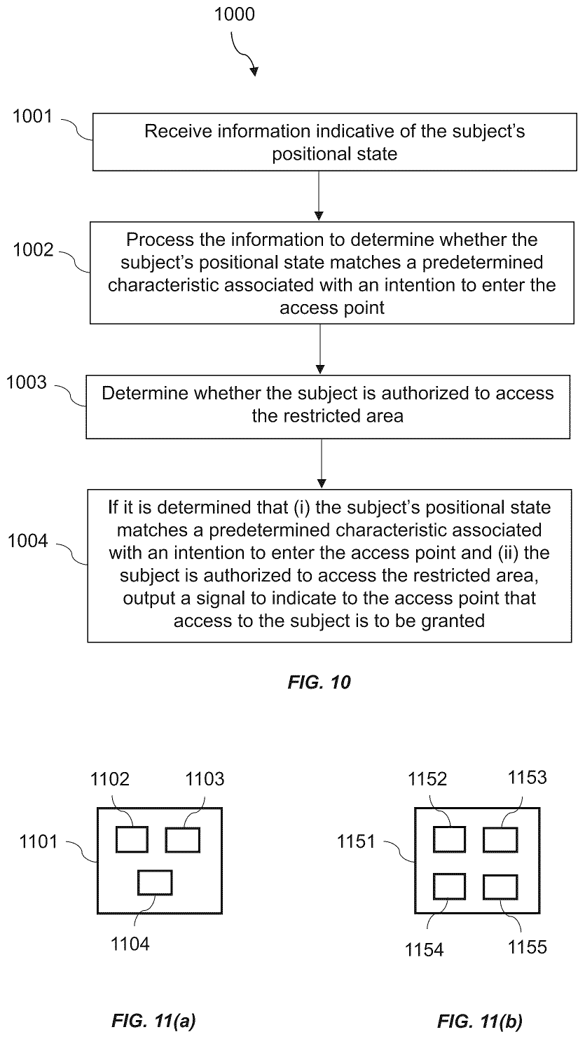

FIG. 10 shows an example of a method for implementation at a control unit for an access point via which access to a restricted area can be granted to a subject. At step 1001, the method comprises receiving information indicative of the subject's positional state. At step 1002, the method comprises processing the information to determine whether the subject's positional state matches a predetermined characteristic associated with an intention to enter the access point. At step 1003, the method comprises determining whether the subject is authorized to access the restricted area. At step 1004, if it is determined that (i) the subject's positional state matches a predetermined characteristic associated with an intention to enter the access point and (ii) the subject is authorized to access the restricted area, the method comprises outputting a signal to indicate to the access point that access to the subject is to be granted.

The control unit may be located at the access point (for example at an access control reader), at the device carried by the user, in the cloud, or at some other location. The control unit may be distributed across multiple entities which may each perform any of the steps of the method above.

The present approach can advantageously infer whether the subject is approaching the access point and intends to enter it, and only permit access when it is determined that the subject is intending to access the access point. The above approach may reduce instances of the access point being unlocked when the bearer of the access token is not intending to approach the access point and enter it. The present approach can allow a user to enter the access point without having to interact with the reader for contract-free admission, but in a more secure matter that can reduce the chance of unauthorised persons opportunistically gaining access. By only permitting access when it is determined that the subject is intending to enter the access point, this reduces the chance of an unauthorised person gaining access to the restricted area.

One problem with portable devices such as device 108 is that they require a battery or other power source to power the processor and/or transmitter. It may be desirable to preserve the life of the power source of the device for as long as possible. This may be done by selectively deciding which data to process and how, and/or how frequently to process the data.

If it is detected that the power level is below a predetermined level, the device may only use TDoA, rather than two way ranging, for example. Alternatively, the control unit may determine the location using ToF data using two way ranging from one of the positioning units, rather than for three, which may be more computationally expensive, and thus use more power from the power source.

In some implementations, the one or more processors of the control unit may be configured to receive one or more first signals comprising information indicative of the subject's positional state and determine a first positional state of the subject based on the one or more first signals and/or a first technique. If it is determined that the subject's first positional state matches a first predetermined characteristic associated with an intention to enter the access point (such as the subject being within a first predetermined distance of the reference point), the one or more processors may be configured to receive one or more second signals comprising information indicative of the subject's positional state and determine a second positional state of the subject based on the one or more second signals and/or a second technique. If it is determined that the subject's second positional state matches a second predetermined characteristic associated with an intention to enter the access point (such as the subject facing a direction that is within a predetermined angular range of the reference point, or reference orientation), and that the subject is authorized to access the restricted area, the one or more processors may output a signal to indicate to the access point that access to the subject is to be granted.

For example, the locating system may initially determine the positional state of the subject using a first localization technique, such as signal strength in dependence on a Bluetooth signal. This is less accurate than localization using UWB, but can use less energy from the power source and can then trigger the start of UWB location determination, which is more accurate. Once the positional state of the subject has been determined using the first localization method and the subject has been detected as being, for example, within a predetermined distance of the reference point using the first localization technique, the locating system may then use a second localization technique, for example using a UWB signal and a trilateration technique, to determine the positional state of the subject more accurately. In some implementations, the device may send identity information to the control unit once it is within the range of the first localization technique. More generally, the control unit may be configured to receive identity information corresponding to the subject (and/or the device may be configured to send such information to the control unit) if it is determined that the subject's positional state matches a first predetermined characteristic associated with an intention to enter the access point.

One exemplary scenario will now be described in more detail. In this example a positioning unit is integral with the access control reader for the access point. The device carried by the subject may listen for a Bluetooth Low Energy (BLE) signal from the positioning unit. Once the device detects a BLE signal from the positioning unit, the device may perform an initial exchange to send the device's certificate (i.e the subject identification information) to the access control reader. Sending the certificate generally has no security implications (if it is, for example, a signed public key), nor does it demonstrate intent of the subject to approach the access point.

In the BLE beacon signal from the positioning unit may be included the serial number of certificate authority (CA) certificates recognised by the device. This may allow the device to determine whether the access point it detects is one belonging to the same customer. If the device does not have a certificate signed by one of the advertised CA certificates, this allows the device to determine that the access control reader will not trust its certificate. In this case, the device may not initiate a ranging session or transmit the certificate, allowing a battery saving in cases where ranging will not result in being able to open a door. The access control reader may cache the device's certificate so as to avoid the need for transmitting it multiple times, reducing battery usage on the device.

If the device detects motion, for example through an inbuilt accelerometer, and is within a predetermined distance of the access point (for example with a minimum required BLE signal strength), a ranging session may be started. The locating system may determine the location of the subject and the distance of the subject from the reference point at the access point. Once the distance of the subject from the reference point at the access point has been determined, the next ranging session may be scheduled. The time to the next ranging session may be chosen in order to minimise use of battery on the devices, and to multiplex the positioning unit's time between different devices carried by different subjects. If a device is determined as being far from the access point, there may be longer delay before the next ranging session. If the device is near the access point, the next ranging session may be initiated sooner.

If the device is determined to be adjacent to and outside the access point, the access point may be unlocked immediately. If the device is already inside the restricted area, a ranging session may not be scheduled again until the access point is opened and the subject exits.

After the second ranging session (which may, for example, be performed only if the device was determined to be moving during the first ranging session), an estimate of velocity (or other positional state) may be made to help decide if the subject is approaching and/or intending to enter the access point, and to decide when next to schedule a further ranging session. If the device is determined to be moving more quickly towards the access point, another ranging session may be scheduled sooner than if it was determined to be moving slowly, or moving away from the access point.

If it is determined that the subject is intending to enter the access point, the device may send a signed request for access to the reader via Bluetooth. If the algorithm is run on the device (or if the subject interacts with the device to explicitly tell it to open the access point), the device may do this directly. If the algorithm is run on the access control reader, the reader may send a message to the device asking to be sent a signed request. This request may have a very short lifetime, to prevent replay.

The above process may be repeated until the device is out of Bluetooth range of the positioning unit.

The system may perform active position sensing (for example via data exchange sessions between the device carried by the subject and one or more positioning units of the locating system) less often if the subject is determined to be stationary or is distant from the access point based on data acquired during the preceding data exchange session. The rate of sensing may be increased if significant movement is detected, or as the subject is detected to be approaching and/or intending to enter an access point. This may help to prolong the battery life of the device.

In order to reduce power source (e.g. battery) usage, and minimise the time usage of the UWB spectrum, the system may coordinate between multiple positioning units to choose which positioning unit is to perform ranging with a particular device. For example, there may be three positioning units within Bluetooth range from a single device, and it may be known that each positioning unit is adjacent an access point (for example, within the access control reader for an access point), and the access points are known to be 10 m apart in a triangle. If the device is detected to be within 5 m of any positioning unit, there is no need to range to any of the other positioning units, as it is known that the device is more than 5 m from those positioning units. Only if the device moves further away from the positioning unit with which it currently has a ranging session may it then hand it over to range with a different positioning unit. Therefore, the one or more processors may be configured to select a positioning unit of the locating system with which the device carried by the user is to exchange data in a second data exchange session based on information indicative of the subject's positional state obtained during a first data exchange session (earlier than the second data exchange session).

Mechanisms such as TDoA may be used to allow devices to calculate the distance from the device to all positioning units with a single Blink message, which has significantly reduced power requirements for the device, or Reverse TDoA, which allows multiple devices to calculate their distances to multiple positioning units. To do this, it is preferable that the clocks of the positioning units are closely synchronised. Synchronising clocks is easier if all of the positioning units are connected to the same controller. Clocks may alternatively be synchronised over UWB.

Using conventional ranging, a positioning unit, or anchor, can only measure range to a single device, or token, at a time. If there are multiple devices in a small area, there may be a limit on how many devices can be located, as time is divided between devices. By using the previously discussed mechanisms to control the rate at which each device is ranged, this can be mitigated by intelligently deciding which are the most relevant to measure the range.

In some areas (for example areas in which it is expected that there may be a large number of devices in a small space of time) there may be multiple positioning devices to permit the use of methods using TDoA. In this case, the device can determine its distance to all positioning units. By using a portable device as an access token with a connection to the cloud, the device can acquire a map of the space, and the device can either make the decision to unlock the access point when the device is acting as the control unit, or transmit an accurate location over the cloud connection to a control unit located at the access point (for example, at an access control reader).

Additionally, the control unit may be configured to send the signal to the access point to indicate to the access point that access to the subject is to be granted if the subject has actively shown intent to enter the access point. For example, the device may comprise a button, or display a virtual button, on a user interface. Pressing the button may indicate to the control unit that access to the subject should be granted when other heuristics do not indicate an intention to enter to the access point. This may alternatively be detected using an accelerometer to detect a tap on the device.

These methods may also be used in the case of tailgating to establish how many authorised users have passed through an access point. In conjunction with a method of people counting, such as infra-red or video-based people counting, this can detect whether an unauthorised person has gained access through tailgating.

The device 108, control unit 110, access control reader 109 and each positioning unit 111 may each comprise a processor and a memory. The processor may be implemented as dedicated hardware in the device, such as a processing chip. The memory is arranged to communicate with the respective processor. Memory may be a non-volatile memory. Each device may comprise more than one processor and more than one memory. The memory may store data that is executable by the processor. By executing program code contained in such data, the one or more processors may perform functions as described herein. The memory may store such program code in a non-transitory manner. The processor may be configured to operate in accordance with a computer program stored in non-transitory form on a machine readable storage medium. The computer program may store instructions for causing the processor to perform its methods in the manner described herein.

Each of the device, control unit, access control reader and each positioning unit may also comprise a transceiver for receiving and/or sending data from and/or to one or more of the other entities.

Each device also comprises a power source or is connectable to mains power. For example, the positioning units and/or the control unit and/or the access control reader having fixed locations in the building may be hard wired to the mains supply. The user device may comprise a battery, as discussed above. This allows the user device to be portable and carried by the user. The battery may be rechargeable and/or replaceable.

FIG. 11(a) shows an example of a device 1101 that may be a control unit, an access control reader, or a positioning unit (or other locating system). The device 1001 comprises a processor 1102, a memory 1103 and a transceiver 1104. FIG. 11(b) shows an example of a portable device 1151 comprising a processor 1152, memory 1153, transceiver 1154 and a battery 1155. The processor of the control unit could be implemented as a physical processing unit or could be a logical function that is distributed between multiple physical processing units.

In further embodiments, the control unit may be configured to assess whether a particular subject is in possession of an access device and only allow access to a subject showing intent to enter the access point if it is determined from the assessment that the subject is in possession of an access device and is authorized to access the restricted area.

The control unit may be configured to correlate the location of an access device with a location of a subject determined from one or more images or a video of the area in the vicinity of the access point. The control unit may correlate the positional state of the access device with the positional states of one or more subjects detected from data acquired by an imaging device (for example, from one or more images or videos). This may enable the control unit to assess which of multiple subjects detected by the imaging device is in possession of the access device. Access may be given to the subject determined to be in possession of the access device.

This may improve security by reducing the risk of incorrect opening of the access point due to a subject who is not in possession of the access device approaching the access point, or being near it, at the time that a subject who does have a valid access device is also there.

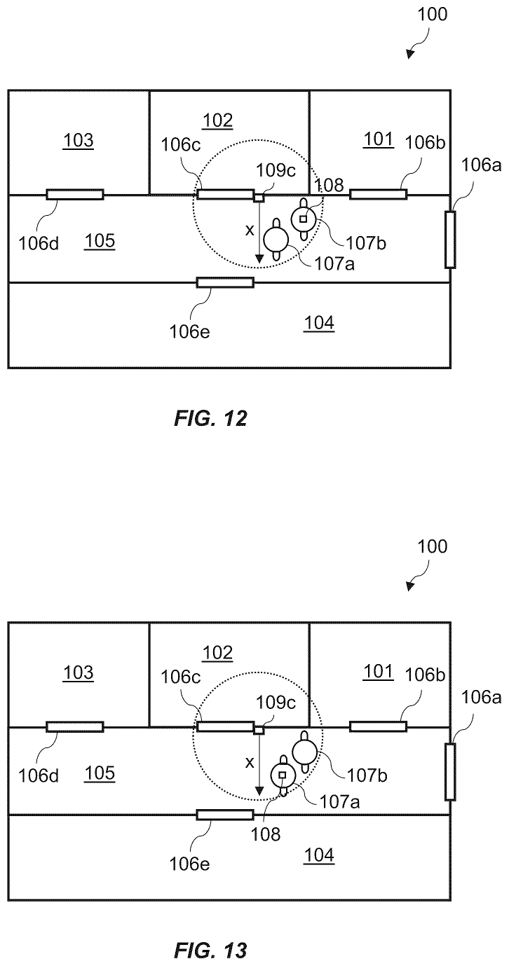

In the exemplary scenario shown in FIG. 12, a first subject 107a is showing intent to enter the access point 106c. For example, the subject 107a may be detected as slowing down in the vicinity of the access point. A second subject 107b is carrying a device 108 and is authorized to enter the access point. The second subject 107b is not showing intent to enter the access point but is carrying an authorized token on the device 108. The second subject 107a continues moving down the corridor 105 at the same speed. Both subjects 107a, 107b are within a predetermined distance x of the access point 106c. In this case, the control unit may detect than the access device is in the vicinity of the access point and determine intent to enter for the other person.

In such a situation, it may be desirable to determine whether the subject determined to be showing intent to enter the access point is the subject in possession of the access device. By determining that the subject for whom intent to enter the access point is determined is in possession of the access device, unauthorized entry by a person not carrying the access device may be avoided.

This may, for example, be done by correlating the positional state of the access device with the positional state of a subject who is determined to have intent, and only allow access to the subject if they are determined to be in possession of an access device and are authorized to enter the restricted area. For example, the location of a subject could be determined in 3D or 2D using one or more imaging devices. The location of the access device might only be known as a distance from the access point, but could be correlated to the location of the subject determined from data captured by the one or more imaging devices. This may allow the control unit to determine that the subject is in possession of the access device.

In the exemplary scenario shown in FIG. 13, a first subject 107a is showing intent to enter the access point 106c. For example, the subject 107a may be detected as slowing down in the vicinity of the access point. A second subject 107b is also moving in the vicinity of the access point 106c. In this example, the subject 107a is carrying the access device 108 and is showing intent to enter the access point 106c. The location of the access device 108 can be correlated to the location of the subject 107a. Because the subject 107a has been determined as being in possession of the access device, the subject 107a can be granted access.

In another example, there may be a subject inside a room with an authorized access device (i.e. an access device storing an identifier that corresponds to a stored list of authorized subjects) and another subject outside the door showing intent to enter who does not have an access device. Correlating the position of the access device with the position of a subject would ignore the validated access token if there is somebody located inside the door (and may also be dependent on whether there is someone outside the door).

In some implementations, the one or more imaging devices (for example, cameras) from which a location or other positional state of a subject can be determined may be in constant operation (in other words, operates continuously). That is, an imaging device does not turn on in response to detecting the access device, but is already in operation. In other words, the imaging device(s) operate independently of whether there is an access device detected within range of the imaging device. This may allow the system to use pre-existing closed-circuit television cameras installed in a building. With such a system, the potential intent of the user to enter the access point can be monitored before the access device has come into range of the control unit (or positioning unit supplying data to the control unit). This may allow for the provision of more information that can be used to infer the intent of the subject, and may enable the use of shorter-range access devices, which might themselves be less likely to accidentally grant access to the wrong person.

Assessing whether the subject is in possession of the access device, for example by correlating the respective locations of the access device and a subject, may help to provide further accuracy in determining whether access to the restricted area should be granted to a subject. In some cases, it might be easier to correlate the access device to a subject detected in an image or video to assess whether the subject is in possession of the access device when the subject is further from the access point. For example, when the subject is further from the access point, they may be in more open space, rather than in a crowded area closer to the access point. The assessment may be performed at a time when the position of the subject is determined to be greater than a predetermined distance from the access point. Once the positional state of the access device has been determined to match the positional state of a subject, or that the subject is in possession of the access device has been otherwise assessed, the subsequent positional state of the subject may be monitored, for example, in dependence on data captured by one or more imaging devices only (and not by tracking the access device by monitoring its positional state) to determine the subject's intent (i.e. to determine whether the positional state of the subject matches a predetermined characteristic associated with an intention to enter the access point). Subsequently tracking that particular subject assessed to be in possession of the device in an image or video feed of the area in the vicinity of the access point may allow for better identification of whether that subject is intending to enter the access point, rather than just passing nearby, and/or may help to avoid confusion with other subjects who are close to the subject in possession of the access device.

In one implementation, the intent of the subject to enter the access point (i.e. whether the positional state of the subject matches a predetermined characteristic associated with an intention to enter the access point) may be determined when the subject is at a distance that is greater than a predetermined distance from the access point. For example, the subject's intent to enter the access point may be determined before the access device has come into range of the access point. For example, a subject may turn off a corridor to move up a flight of stairs leading to the access point. From this positional state of the subject, intent to enter the access point may be determined. That is, the positional state of the subject can be determined to match a predetermined characteristic associated with an intention to enter the access point. Once the access device has come into range of the access point or locating system of the access point (for example, within range of the reader of the access point so that radio frequency signals emitted by the access device can be received at the reader), it may be inferred from the determined position of the access device and the determined position of the subject that the subject is in possession of the access device. The subject in possession of the access device and showing intent to enter the access point can then be granted access to the restricted area. In other words, the assessment of whether the subject is in possession of the access device may be subsequently performed when the subject is at a distance from the access point that is less than a predetermined distance (which may be the same predetermined distance as above where the intent is assessed, or a different predetermined distance).

In some embodiments, the detected identity information may be used to augment an image or video feed, for example by annotating the feed with labels showing the identity of one or more subjects shown. The identities could be displayed to a user monitoring a video feed where faces may not be able to be recognised, for example because people are wearing masks. The displayed identity information for detected people within the scene may be provided from one or more of data captured by an imaging device (for example, using facial recognition), and from identity information stored on a carried access device.

In some implementations, if it is determined that the identity determined from the access device does not match the identity of the carrying subject determined from one or more images (for example, using facial recognition or gait analysis), an alert may be raised. In some cases, the control unit may be configured to send an alert, for example to the security team or the owner of the access token, optionally with one or more images of the person who is carrying the access device. In some cases, the control unit may be configured to automatically block access if the identity of a user determined from the access device does not match the identity of the carrying user determined from one or more images, for example by disabling the access device.

In another implementation, the one or more imaging devices may detect multiple subjects in the vicinity of the access point. The control unit may determine which of the multiple subjects is in possession of the access device. This may be performed by correlating the position of the access device with the position of each subject, as described above, to determine which of the subjects is in possession of the access device. The control unit may determine whether the subject determined as being in possession of the access device has intent to enter the access point by determining whether the positional state of the subject and/or the access device matches a predetermined characteristic associated with an intention to enter the access point.

In another implementation, the subject assessed as being in possession of the access device is a first subject. If a second (or further) subject is detected as being within a predetermined distance of the first subject from one or more images captured by the one or more imaging devices, the control unit may be configured to perform a security action. The security action may comprise one or more of the following: raising an alert, reducing the amount of time that the first subject can gain access to the restricted area, permitting access to the first subject only when the first subject is within a predetermined distance of the access point, preventing further access once the first subject has entered the access point and triggering a further layer of verification in order to allow access to the first subject. For example, the control unit may be configured to only output a signal to allow the subject access to the restricted area if both identity data stored at the access device and the identity of the subject determined from data captured by one or more of the imaging devices match.

In a further example, an imaging device on the outside of the access point may detect a subject in the vicinity of the access point who is not authorized to enter the restricted area (who may, for example, be lurking). The control unit may detect an authorized access device inside the restricted area. When an authorized subject in possession of the access device tries to exit the restricted area through the access point, a notification could be sent to the detected access device of the user exiting the restricted area to warn them that there is a subject who is not authorised to enter the restricted area in the vicinity of the access point. The notification could be, for example, a warning or may require the authorized user to acknowledge this notification before being allowed to exit the restricted area through the access point. This may prevent unauthorized subjects from gaining access opportunely when an authorized subject exits the restricted area.

In cases where the positional state of the subject and the access device are determined as distances of the subject and the access device from the access point or a rate of charge thereof, it may be assessed that the subject is not in possession of the access device when the access device is remaining still, but the subject is moving (i.e. there is a change in their position from the access point over time). From this, it can be assessed that they are not in possession of the detected access device and the signal will not be output.

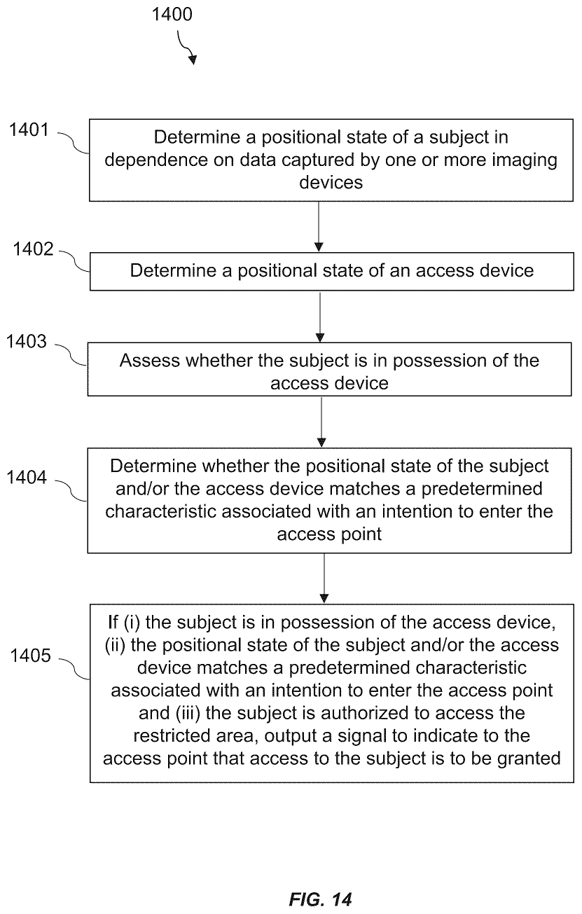

FIG. 14 shows the steps of an exemplary method for implementation at a control unit for an access point via which access to a restricted area can be granted. At step 1401, the method comprises determining a positional state of a subject in dependence on data captured by one or more imaging devices. At step 1402, the method comprises determining a positional state of an access device. At step 1403, the method comprises assessing whether the subject is in possession of the access device. At step 1404, the method comprises determining whether the positional state of the subject and/or the access device matches a predetermined characteristic associated with an intention to enter the access point. At step 1405 the method comprises, if (i) the subject is in possession of the access device (as determined from the assessment), (ii) the positional state of the subject and/or the access device matches a predetermined characteristic associated with an intention to enter the access point and (iii) the subject is authorized to access the restricted area, outputting a signal to indicate to the access point that access to the subject is to be granted. This method may further improve security by only allowing access to a subject who is assessed as being in possession of an access device.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. The applicant indicates that aspects of the present invention may consist of any such individual feature or combination of features. In view of the foregoing description, it will be evident to a person skilled in the art that various modifications may be made within the scope of the invention.

1. A control unit for an access point via which access to a restricted area can be granted to a subject, the control unit comprising one or more processors configured to:
determine a positional state of a subject in dependence on data captured by one or more imaging devices;
determine a positional state of an access device;
assess whether the subject is in possession of the access device; and
determine whether the positional state of the subject and/or the access device matches a predetermined characteristic associated with an intention to enter the access point; and
if (i) the subject is in possession of the access device, (ii) the positional state of the subject and/or the access device matches a predetermined characteristic associated with an intention to enter the access point and (iii) the subject is authorized to access the restricted area, output a signal to indicate to the access point that access to the subject is to be granted.

2. The control unit as claimed in claim 1, wherein the one or more processors are configured to determine that the subject is authorized to access the restricted area if one or more of the following is true: (i) the subject is in possession of the access device and the access device is an authorized access device and (ii) if an identity of the subject determined from data captured by an imaging device matches a stored list of authorized subjects.

3. The control unit as claimed in claim 2, wherein the one or more processors are configured to determine that the subject is authorized to access the restricted area if identity data stored at the access device corresponds to the identity of the subject determined from data captured by one or more of the imaging devices.

4. The control unit as claimed in claim 2, wherein the one or more processors are configured to raise an alert if identity data stored at the access device does not correspond to the identity of the subject determined from data captured by the imaging device.

5. The control unit as claimed in claim 1, wherein the subject is a first subject and wherein the one or more processors are configured to, if a second subject is detected as being within a predetermined distance of the first subject from one or more images captured by the imaging device, perform a security action.

6. The control unit as claimed in claim 5, wherein the security action comprises one or more of the following: raising an alert, reducing the amount of time that the first subject can gain access to the restricted area, permitting access to the first subject only when the first subject is within a predetermined distance of the access point, preventing further access once the first subject has entered the access point and triggering a further layer of verification in order to allow access to the first subject.

7. The control unit as claimed in claim 1, wherein the one or more processors are configured to determine whether the subject is in possession of the access device when the access device and the subject are more than the predetermined distance from the access point.

8. The control unit as claimed in claim 7, wherein the one or more processors are configured to subsequently determine whether the positional state of the subject matches a predetermined characteristic associated with an intention to enter the access point in dependence on data captured by an imaging device.

9. The control unit as claimed in claim 1, wherein the imaging device is configured to capture images independently of the distance of the subject and/or the access device from the access point.

10. The control unit as claimed in claim 9, wherein the imaging device is a closed-circuit television camera installed in a building.

11. The control unit as claimed in claim 1, wherein the control unit is configured to not permit access to the subject if it is determined that the subject is not authorized to enter the restricted area and/or that the positional state of the subject and/or the access device does not match a predetermined characteristic associated with an intention to enter the access point.

12. The control unit as claimed in claim 1, wherein the one or more processors are configured to determine the positional state of the subject in dependence on information indicative of the subject's positional state, wherein the information comprises an indication of one or more of a location of the subject, a speed of the subject, a velocity of the subject, an orientation of the subject, a pose of the subject and a trajectory of the subject, or a change thereof with respect to time.

13. The control unit as claimed in claim 1, wherein the one or more processors as configured to determine the positional state of the access device in dependence on one or more radio frequency signals transmitted by the access device.

14. The control unit as claimed in claim 1, wherein the access device is a fob, a badge or a user device.

15. The control unit as claimed in claim 1, wherein the predetermined characteristic associated with an intention to enter the access point comprises one or more of the following: the location of the subject and/or the access device is within a predetermined distance of the access point, the speed or velocity of the subject and/or the access device is less than a predetermined threshold and the orientation of the subject and/or the access device is within a predetermined angular range with respect to the access point.

16. The control unit as claimed in claim 1, wherein the access point comprises an electrically controlled lock and wherein the control unit is configured to send the signal to the electrically controlled lock and wherein the signal causes the lock to transition from a locked state to an unlocked state.

17. The control unit as claimed in claim 1, wherein the one or more processors are configured to:
receive one or more first signals comprising information indicative of the subject's positional state;
determine a first positional state of the subject based on the one or more first signals and/or a first technique;
if it is determined that the subject's first positional state matches a first predetermined characteristic associated with an intention to enter the access point:
receive one or more second signals comprising information indicative of the subject's positional state;
determine a second positional state of the subject based on the one or more second signals and/or a second technique;
if it is determined that the subject's second positional state matches a second predetermined characteristic associated with an intention to enter the access point, and that the subject is authorized to access the restricted area, output the signal.

18. The control unit as claimed in claim 1, wherein the one or more processors are configured to initiate one or more data exchange sessions to acquire information indicative of the subject's positional state, wherein the one or more processors are configured to determine a time period between the initiation of a first data exchange session and a second data exchange session based on information indicative of the subject's positional state obtained during the first data exchange session.

19. A method for implementation at a control unit for an access point via which access to a restricted area can be granted, the method comprising:
determining a positional state of a subject in dependence on data captured by one or more imaging devices;
determining a positional state of an access device;
assessing whether the subject is in possession of the access device; and
determining whether the positional state of the subject and/or the access device matches a predetermined characteristic associated with an intention to enter the access point; and
if (i) the subject is in possession of the access device, (ii) the positional state of the subject and/or the access device matches a predetermined characteristic associated with an intention to enter the access point and (iii) the subject is authorized to access the restricted area, outputting a signal to indicate to the access point that access to the subject is to be granted.

20. A computer-readable storage medium having stored thereon computer readable instructions that when executed by a computer cause the computer to perform the method of claim 19.
